(19) United States
(12) Patent Application Publication
(10) Pub. No.: US 2004/0102988 A1
(43) Pub. Date: May 27, 2004

(54) Computerized system and method for maintenance of plant in the food and luxury food industry

(76) Inventors: Frank Andresen, Erlangen (DE); Michael Schmidt, Stuhr (DE)

Correspondence Address: STAAS & HALSEY LLP, SUITE 700, 1201 NEW YORK AVENUE, N.W., WASHINGTON, DC, 20005, US

(21) Appl. No.: 10/468,758

(22) PCT Filed: Feb. 26, 2002
(86) PCT No.: PCT/DE02/00674

(30) Foreign Application Priority Data
Feb. 26, 2001 (DE) 101 09 229.6

(51) Int. Cl. G06F 17/60

(52) U.S. Cl. 705/1

(57) ABSTRACT

The invention relates to a computerised system and a method for the maintenance of a plant for the production of goods, preferably in the food and luxury food industry. The aim of the invention is to provide a computerised system and a method as above by means of which the technical and economical costs for maintenance of a plant can be reduced and the availability of the plant can be increased. According to the invention, the plant in particular comprises production machines for batch production, whereby the memory unit contains a non-plant specific relational data bank for the determining of detailed plant data, for example, individual components, at least one non-plant specific main tool (software main tool) and further plant specific tools (software tools) provided for the execution of the data aspect of the maintenance. According to the method, a maintenance volume for the plant is divided into an electrical main section, a mechanical main section, a buildings technology main section and a production logging section, whereby the electrical main section, the mechanical main section and the buildings technology main section are each sectioned into a planned and unplanned maintenance volume section and are undertaken according to electronically produced instruction cards.

### DESCRIPTION

Computerized system and method for maintaining a plant in the food and luxury consumables industry The invention relates to a computerized system and a method for maintaining a plant for manufacturing goods, preferably in the food and luxury consumables industry, e.g. a coffee roasting establishment.

The invention is based on the object of developing a computerized system and a method for maintaining such a plant which can be used to reduce the technical and economic outlay for maintaining the plant, on the one hand, and in addition is intended to be used to achieve an increase in the plant availability. Both the operating safety and the process safety of the plant are intended to then be ensured; the pursued method is additionally intended to be as flexible as possible, to leave a large amount of room for innovation and thus to simplify the future orientation of the plant overall.

Part of the object is to specify a computerized system which allows maintenance of the industrial plants to be optimized and billed for not just for plants in the food and luxury consumables industry, for which it is particularly suitable, but also for other plants. In particular, this is intended to allow the maintenance to be billed for in relation to success.

Specifying the computerized system is the superordinate object of the invention, while the method for maintenance is a specific object.

The superordinate object is achieved in accordance with the wording of claim 1. In this case, the use of a relational database, that is to say a database in which changes to a position are adopted in all areas of the database, chooses a database form which is particularly suitable for achieving the object. The information about the plant, plant components and their individual parts is certain always to be at the most up-to-date level. Such databases are already known per se, and their use for maintaining a plant is particularly advantageous. The use of a main tool is also known in computer technology, for example in the form of the program “Navision”. For the fist time, however, a program of the type such as the Navision program is assembled in the form of a relational database together with other tools created on a plant-specific basis to form a software tool which, in combination with a suitable business model, permits optimum maintenance of a plant, particularly in the food and luxury consumables industry.

In one refinement of the computerized system, said system has a plant model in list form for machines and machine parts in the relational database, which plant model is designed to operate on the basis of SAP stipulations, for example. It is thus possible to use software which covers all the individual parts of a plant and is frequently used in the industrial sector. The purchasing side of plant management and the logistics can also be included in maintenance using this program. All in all, a novel, continuously working system with novelly combined software is obtained.

In another refinement of the invention, the computerized system is designed to operate with standardized data relating to usability, utilization level and consumption of the machines. In addition, it has useful-life lists and lists for necessary maintenance measures depending on the useful life of machines and the actual use times. Thus, a map of the plant condition from which it is possible to generate the necessary measures, supplementary orders etc. is obtained in list form.

The main tool is advantageously designed for specifically handling individual sections, the measures for the individual sections respectively being entered into the main tool on the basis of specific tasks. Thus, the maintenance is organized in a new way.

To implement the maintenance measures, the computerized system contains maps of the maintenance processes in list form. Hence, particularly advantageously, the system can be used by people who do not need to understand the individual logic processes in the plant. In this case, the use of the relational database ensures that the individual maintenance processes are also mapped in the lists in which they have not been recorded. All in all, the map of the maintenance processes obtained is thus always at the most current level.

In one particularly advantageous computerized embodiment, the system for handling the maintenance processes is set up on the basis of electronic instruction cards which can be displayed. Hence, a clear method sequence for the maintenance processes is achieved and can be displayed on a monitor or even printed for control purposes. The instruction cards form the basis of the individual maintenance processes and can be controlled particularly securely. The actual handling of the maintenance processes takes place using computer-generated flowcharts, which do not need to be displayed.

Since the computerized system is also used for billing by recording the actual machine use, it advantageously has operating data terminals or machine sensors used in relation to machines for the purpose of data entry. Hence, an objective billing and response prediction base exists. The [lacuna] individual operating data terminals or the machine sensors can also take place as a result of an appropriate recordings in a plant control system, if such a system is present. In this case, data are recorded and output by individual machines, by machine groups and by the whole plant. If the plant, as is frequently the case, has only machine groups which are networked through conveying means (isolated operation) and which, furthermore, also frequently originate from different manufacturers and are of different ages, the plant control system will record only data which it is able to access. The rest of the data are recorded by the operating data terminals or by recordings made by the supervisory personnel. All in all, however, what is obtained is a reconstructable base for the billing and prediction data.

For the purpose of billing between the maintenance company, possibly even a company which maintains and operates the plant, that is to say an external service provider, and the firm which owns the plant and sells the goods produced, the computerized system contains algorithms for calculating the availability achieved in practice in relation to the availability which can be achieved in theory; in addition, it contains algorithms for calculating a success-dependent remuneration for the maintenance and/or operation.

While the general object is to specify a computerized system for optimizing and billing for the maintenance of an industrial plant, one specific object is the procedure for making such a complex object manageable.

The invention achieves the specific object by means of a method for maintaining, for example, a plant in the food and luxury consumables industry, e.g. a coffee roasting establishment, in which a maintenance volume arising in the plant is split into an electrical main section, a mechanical main section, a buildings technology main section and a production-accompanying sector, with the electrical main section, the mechanical main section and the buildings technology main section each being broken down into a plannable and an unplannable maintenance volume sector.

In order to be also able to record changes and further developments in the plant in terms of maintenance volume, the electrical main section, the mechanical main section and the buildings technology main section are each preferably assigned a special-measures or project volume sector, which makes it possible to take into account the aforementioned further developments and changes in the plant.

It can also be expedient if, for the purpose of taking into account the maintenance management when stipulating the entire maintenance volume which arises in the plant, the electrical main section, the mechanical main section and the buildings technology main section each have a maintenance management volume sector.

Preferably, the electrical main section, the mechanical main section and the buildings technology main section each have an associated spares procurement and furnishing volume sector.

To improve the organization and implementability of the maintenance in the plant further, the plannable maintenance volume sector of the electrical main section, of the mechanical main section and of the buildings technology main section is respectively split into an inspection sector, a servicing sector, a repair sector, an expendable-part procurement and furnishing sector and a consumables procurement and furnishing sector.

In addition, it can be expedient if the timing for the unplannable maintenance volume sector of the electrical main section, of the mechanical main section and of the buildings technology main section is respectively split into a primary time sector and a secondary time sector, since considerable differences can arise with regard to the personnel working on the plant and with regard to the availability of personnel for eliminating faults and carrying out repairs which are required without delay.

The electrical main section is preferably divided into an automation section, a control level section, a measurement and control section, a low voltage section, a drive and motor section, a valve section, a labeling and inscription device section and a documentation section.

Similarly, it is advantageous if the mechanical main section is divided into a fan section, a burner technology section, a mechanical engineering section, a mechanical conveying and handling section, an instrumentation section and a vacuum and compressed air section.

Expediently, the buildings technology main section can also be divided into a telephone section, a fire alarm section, an elevator section, a fitter, painter, joiner and roofer section and a heating, sanitation, air-conditioning and ventilation section.

Naturally, depending on the plant which is to be maintained, other main section divisions are also possible.

Preferably, the inventive method can involve the maintenance volume arising in the plant being assigned an EDP sector. For such an EDP sector, it is possible to provide, by way of example, computer-aided handling using a software maintenance tool, which may have been additionally purchased.

Expediently, the maintenance volume arising in the plant is split into individual sections and sectors such that a multiplicity of maintenance segments arises, each of which can be implemented separately. On account of these maintenance segments being able to be implemented separately, the resultant tasks can be allocated in any desired split to different people or groups of people; in particular, each of the maintenance segments produced by splitting the maintenance volume arising in the plant into sectors and sections can be assigned entirely or in part to a group or to a plurality of groups.

In line with one advantageous embodiment of the inventive method, a first stage of a multistage, preferably four-stage process involves those maintenance segments of the inspection, servicing and repair sector which belong to the plannable maintenance volume sector of the electrical main section, of the mechanical main section and preferably also of the buildings technology main section being transferred from one group operating the plant to another group, the latter group being able to be, by way of example, a company specializing in the maintenance of such plants.

Another possibility is for the first stage of the process to involve the maintenance segments which belong to the unplannable maintenance volume sector of the automation section, of the control level section and of the measurement and control section of the electrical main section being assigned to the other group in a comparatively high percentage, preferably 90%, in the primary time sector and entirely in the secondary time sector.

The maintenance segments belonging to the maintenance management volume sector of the electrical main section, of the mechanical main section and of the buildings technology main section can be respectively distributed over the group operating the plant and the other group, preferably in a proportion of 50% each.

In the case of most plants in the food and luxury consumables industry, it is advantageous and expedient if the production-accompanying sector of the maintenance volume arising in the whole plant is respectively implemented by the group which operates the plant.

In line with another advantageous development of the inventive method, the second stage of the preferably four-stage process involves the maintenance segments which belong to the unplannable maintenance volume sector of the low voltage section, of the drive and motor section, of the valve section, of the labeling and inscription section and of the documentation section of the electrical main section being adopted by the other group as required.

In addition, the third stage of the preferably four-stage process involves the maintenance segments which belong to the unplannable maintenance volume sector of the buildings technology main section being able to be adopted by the other group as required.

Accordingly, the fourth stage of the preferably four-stage process involves the maintenance segments which belong to the unplannable maintenance volume sector of the mechanical main section being able to be adopted by the other group as required.

In the case of a method for maintaining a plant in the food and luxury consumables industry which is preferably in the form as outlined above, a technical plant availability value can be ascertained from the ratio between the plant's technical downtime, which is obtained from downtimes based on an inadequacy in the plant design or on inadequate servicing, and the technical busy time, which corresponds to the plants ACTUAL busy time stipulated by the actual utilization level by the production program, which value, when contracts are formed between the group operating the plant and the other group, can result in stimuli and improvements to the extent that the ascertained technical plant availability value can be stipulated as a recompense reference value, with negative or positive deviations from the base value possibly resulting in a reduction or in an increase in the recompense.

Expediently, recompense of the other group on the basis of the technical plant availability value or base value can start at the beginning of the third stage of the preferably four-stage process, outlined above.

To provide a reference value for the respectively subsequent year, it is advantageous if the recompense base value stipulated on the basis of the technical plant availability value ascertained for one year is equated to the agreed annual maintenance budget for the next year which is to be paid to the other group.

In line with another advantageous embodiment of the inventive method, in the event of a negative or positive deviation in the actual technical plant availability value achieved in the current year from the ascertained technical plant availability value for the previous year which has been set aside as a basis for the recompense base value for the current year, the maintenance recompense to be paid to the other group is reduced or increased by 0.5% of the annual maintenance budget agreed for the current year for each percentage point of the negative or positive deviation.

To improve the cooperation between the two groups, it can be advantageous if an increase in the maintenance recompense which is to be paid to the other group per se is preferably split equally between the group operating the plant and the other group.

Accordingly, it can be advantageous if a reduction in the maintenance recompense which is to be withheld from the other group per se is preferably split equally between the group operating the plant and the other group.

The invention is explained in more detail below using an embodiment with reference to the drawing, in which:

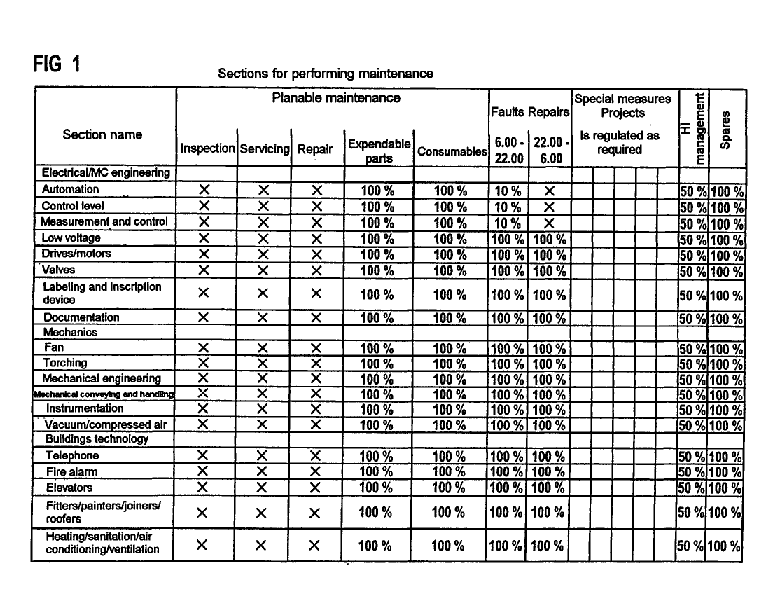

FIG. 1 shows an example of the split or division of the maintenance volume arising in a plant; and

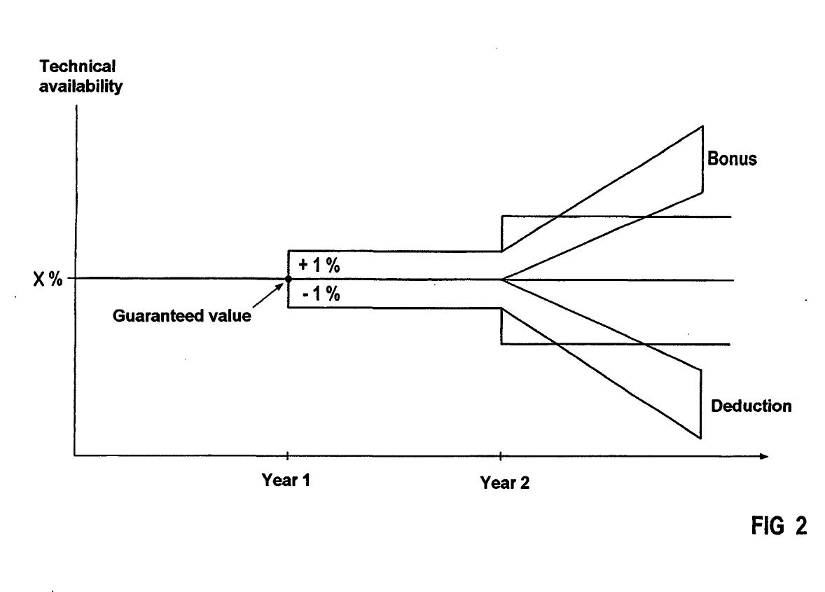

FIG. 2 shows an example of recompense regulation which is dependent on a technical plant availability value.

In one embodiment of an inventive method for maintaining a plant in the food and luxury consumables industry, such a plant, which can be a coffee roasting establishment, for example, is examined and structured precisely with regard to the maintenance measures or actions which are to be performed on it.

In this context, the maintenance measures directly related to production are first combined into a production-accompanying sector.

In addition, the entire maintenance volume arising in the area of the plant is assigned an EDP sector which is handled with computer support, in which case it is entirely conceivable to use an additionally purchased software maintenance tool (CMMS).

Furthermore, the rest of the maintenance volume arising in the whole plant is split into an electrical main section, a mechanical main section and a buildings technology main section.

The electrical main section, the mechanical main section and the buildings technology main section are each divided into a plannable and unplannable maintenance volume sector.

To take into account further development and improvement measures on the whole plant, the electrical main section, the mechanical main section and the buildings technology main section additionally each have a special-measures or project volume sector. Furthermore, the electrical main section, the mechanical main section and the buildings technology main section each have an associated maintenance management volume sector and a spares procurement and furnishing volume sector.

The plannable maintenance volume sector of the electrical main section, of the mechanical main section and of the buildings technology main section is respectively made up of an inspection sector, a servicing sector, a repair sector, an expendable-part procurement and furnishing sector and a consumables procurement and furnishing sector.

The unplannable maintenance volume sector of the electrical main section, of the mechanical main section and of the buildings technology main section is respectively made up of a primary time component and a secondary time sector, with the primary time sector relating to the actual production period between 6.00 hrs and 22.00 hrs, whereas the secondary time sector relates to the period between 22.00 hrs and 6.00 hrs.

The maintenance volume sectors explained above are obtained from the column split or division in the “Sections for performing maintenance” table shown in FIG. 1. The faults and repairs cited therein are based on the unplannable maintenance volume sector.

The rows of the table shown in FIG. 1 are divided into the electrical main section, the mechanical main section and the buildings technology main section.

The electrical main section has an associated automation section, a control level section, a measurement and control section, a low voltage section, a drive and motor section, a valve section, a labeling and inscription device section and a documentation section.

The mechanical main section has an associated fan section, a burner technology section, a mechanical engineering section, a mechanical conveying and handling section, an instrumentation section and a vacuum and compressed air section.

The buildings technology main section has an associated telephone section, a fire alarm section, an elevator section, a fitter, painter, joiner and roofer section and a heating, sanitation, air-conditioning and ventilation section.

The row-by-row and column-by-column division, shown in FIG. 1, into sections or different sectors results in the creation of a multiplicity of maintenance segments which can be implemented separately.

It is thus possible, by way of example, for the operator of a plant himself to implement only those maintenance segments which have a direct time and personnel relationship with the production-related operation of the plants, whereas external service providers are responsible for implementing other maintenance segments.

When maintenance services are transferred from the operator of the plant to an external service provider, in order to ensure that the know-how relating to maintaining the plant is transferred to the external service provider, such transfers should be performed within the context of a multistage process, the transfer in the exemplary embodiment illustrated below being formed within the context of a four-stage process.

In this case, the process is transferred to the respectively next stage following consultation between the operator of the plant and the external service provider, taking into account the experiences from the respectively previous stage.

In the first stage, the operator of the plant forms the maintenance which accompanies production; that is to say that the production-accompanying sector of the entire maintenance volume arising in the plant is implemented by the operator of the plant. During this first stage, the maintenance segments of the inspection, servicing and repair sector which are associated with the planable maintenance volume at a later time, preferably also of the buildings technology main section are transferred to the external service provider. In addition, the first stage of the aforementioned four-stage process involves the maintenance segments which belong to the unplannable maintenance volume sector of the automation section, of the control level section and of the measurement and control section of the electrical main section being implemented by the external service provider, in a comparatively high percentage, for example 90%, in the primary time sector whereas, in the secondary time sector of said sections, the corresponding maintenance segments are implemented entirely by the external service provider.

The maintenance segments associated with the maintenance management volume sector of the electrical main section, of the mechanical main section and of the buildings technology main section are distributed over the operator of the plant and over the external service provider actually in the aforementioned first stage, specifically to 50% each, for example, as shown in FIG. 1.

Within the first stage, the principles for introducing the maintenance software are formulated and the project organization for the operator of the plant and for the external service provider is introduced.

The second stage involves the external service provider undertaking, in addition to the maintenance segments which he has already undertaken during the first stage, the maintenance segments which belong to the unplannable maintenance volume sector of the low voltage section, of the drive and motor section, of the valve section, of the labeling and inscription device section and of the documentation section of the electrical main section as required. Essential points during the second stage are the further development of the maintenance strategy, the increase in understanding of the process by the external service provider, and the improvement in the maintenance transparency in terms of the economic involvement and the performance within the maintenance software.

During the subsequent third stage of the aforementioned process, the external service provider can then undertake responsibility for the maintenance budget formulated through the experience obtained during the first and second stages. Furthermore, the external service provider undertakes, in addition to the maintenance segments undertaken during the first and second stages, the maintenance segments belonging to the unplannable maintenance volume sector of the buildings technology main section from the operator of the plant as required. In addition, during this third stage of the four-stage process, smooth transfer of the maintenance segments belonging to the unplannable maintenance volume sector of the mechanical main section from the operator of the plant to the external service provider is prepared and initiated.

From the start of the third stage of the four-stage process onward, the operator of the plant can be assured of technical plant availability by the external service provider; in addition, the external service provider can undertake budget security for the maintenance budget which is within his responsibility from this third stage onward, with savings at an appropriate level additionally being able to be prescribed.

During the fourth and last stage of the four-stage process repeatedly mentioned above, the external service provider increases the budget security for the maintenance volume which he has undertaken during the first three stages of the process by means of a continuous improvement process. The maintenance software is further refined and adapted on the basis of the experience obtained; this allows the effectiveness of the undertaken maintenance segments' implementation to be increased. Standardizations which increase utilization levels and span the individual sections and also the main sections are implemented.

The maintenance budget refined during stage three of the process is also the responsibility of the external service provider. In addition to the maintenance segments undertaken during the first three stages of the process, the external service provider undertakes the maintenance segments belonging to the unplannable maintenance volume sector of the mechanical main section from the operator of the plant as required.

For the fourth stage of the process too, the technical plant availability, which the external service provider has assured to the operator of the plant, and also the budget security remain fundamental to the operator of the plant, with a minimum saving sum at an appropriate level again being able to be provided in the external service provider's maintenance budget.

FIG. 1 shows the state of the undertaking of maintenance segments by the external service provider at the end of the first stage of the four-stage process explained above. The maintenance segments fully undertaken by the external service provider are identified by “x” in the table in FIG. 1, whereas the percentages indicated in the rest of the maintenance segments relate to the percentage share of the respective maintenance segment which is still being implemented by the operator of the plant. For the special-measures or project volume sector, no details are given in the table shown in FIG. 1, since respectively adapted regulations should be implemented in this regard for all special measures and projects.

At the end of stage two of the four-stage process explained above, the technical plant availability of the plant which is to be maintained is stipulated as an initial variable for the recompense which is to be paid to the external service provider by the operator of the plant for maintenance segments undertaken by the external service provider. This technical plant availability value is ascertained from the ratio between the plant's technical downtime and the plant's technical busy time. The plant's technical downtime is obtained from downtimes based on an inadequacy plant design or on inadequate servicing. The technical busy time corresponds to the plant's ACTUAL busy time stipulated by the actual utilization level by the production volume.

Reliable values for the technical plant availability are available from the end of the second stage of the four-stage process explained above onward. An average value for the technical plant availability with yearlong validity is thus available from the start of the third stage of the four-stage process onward.

The technical plant availability value ascertained in this manner is taken as a basis for the subsequent year as a guaranteed value, as shown in FIG. 2. If this guaranteed value is observed in the subsequent year, it remains for the recompense, agreed between the operator of the plant and the external service provider, for the maintenance segments undertaken by the external service provider.

If the guaranteed value is undershot by one percentage point, the recompense to be paid to the external service provider for the maintenance segments undertaken by the external service provider is reduced by 0.5% of the plant's respectively agreed annual maintenance budget. Such a reduction of 0.5% arises for each percentage point of the shortfall below the guaranteed value, but limited to a maximum of 10% of the annual maintenance budget.

If the technical plant availability value exceeds the guaranteed value, a bonus amounting to 0.5% of the respectively agreed maintenance budget is similarly obtained for each percentage point of the excess.

As a basis for regulating the bonus or deduction for the subsequent year, it is respectively necessary to stipulate the ascertained technical plant availability for the respective previous year.

Thus, for example, the ascertained technical plant availability value may be 100%. If this technical plant availability value increases to 101% over a defined period, the bonus for an agreed annual maintenance budget amounting to DM 4 000 000.00 is DM 20 000.00. This bonus of DM 20 000.00 goes into an incentive regulation which makes provision for the sum to be split in a ratio of 50% for the operator of the plant and 50% for the external service provider; the bonus is thus DM 10 000.00 for each.

In the first year following ascertainment of the annual maintenance budget, that is to say after stages one and two of the process explained above are complete, savings within the maintenance budget are assured amounting to DM 500 000.00, for example. In the exemplary embodiment illustrated, this sum is based on the efforts for maintenance management.

This shows that the “ROI” starts in the second year following ascertainment of the budget. All savings beyond the aforementioned agreed saving target go into an incentive regulation, which provides for said savings to be split in a ratio of 50% to the operator of the plant and 50% to the external service provider.

As a basis, an annual maintenance budget of DM 4 000 000.00, for which the external service provider is responsible, has been stipulated in the exemplary embodiment illustrated. The assured savings are adapted on a percentage basis as appropriate in the event of a higher or lower annual maintenance budget; with regard to the savings proceeds attained, the halving explained above is retained.

It should be pointed out that fixed prices can be stipulated for the maintenance management during the first and second stages of the four-stage process explained above.

The computerized system is explained with reference to further figures which, like the subclaims, reveal further, including independent, inventive measures.

Specifically:

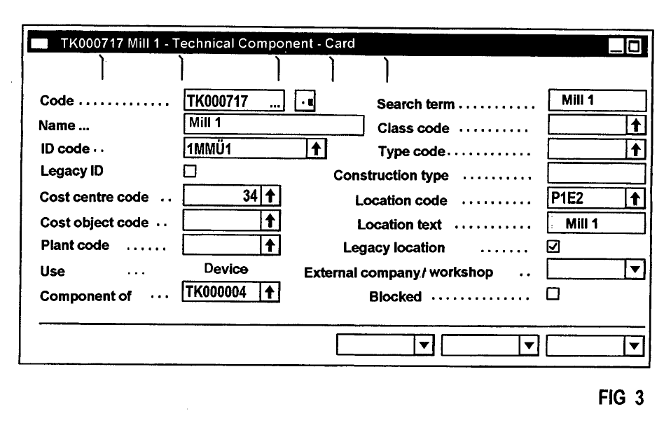

FIG. 3 shows a product card from the mechanical main section;

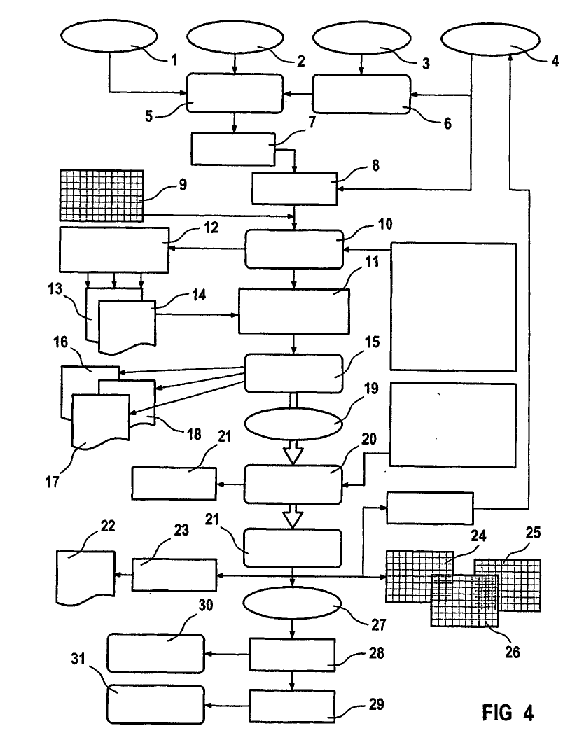

FIG. 4 shows a flowchart for instruction handling as an example of the processes taking place in the computerized system; and

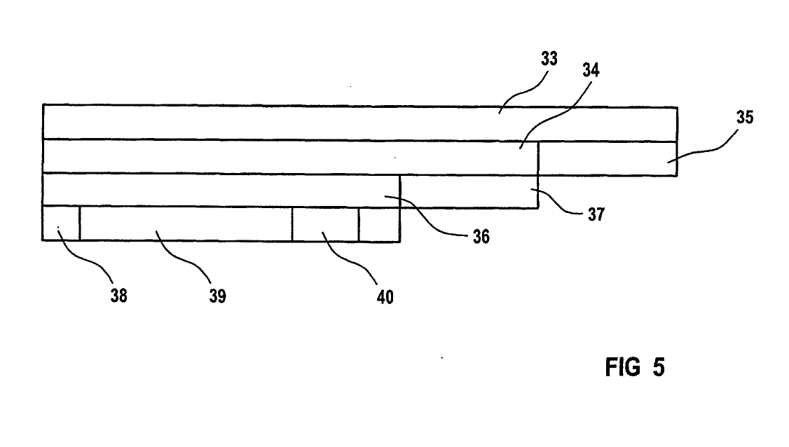

FIG. 5 shows a graphical overview of the availability variables with the algorithm for calculating the plant availability.

FIG. 3 shows the component card of an instruction card. Since part of the mechanical main section is involved, the instruction card is in the form of a technical component card. As can be seen, a component of the plant part TK00004 is involved. The individual parts of the mill, e.g. the motor, the coupling etc., have also been shown in a corresponding form. These parts are recorded in lists having a normal list form, e.g. in Excel. All in all, a complete illustration of all the plant parts with their individual components and their machine parts is thus obtained. The individual machine parts also advantageously produce an article list which can be used for standardization. The details in the technical component card have been standardized and coded. Simple input and control of correct input are thus possible.

FIG. 4 shows a typical computerized sequence using the example of the “Flowchart: Instruction Handling”. Starting from the input 1 (fault) or 2 (maintenance request) or 3 (work preparation) or 4 (follow-up instruction), a system-internal instruction request 5 or a work plan 6 is created which results in a request overview 7 in list form. In 8, the request data are accepted and the instruction is created, the data from the article overview and from the article hierarchy being accepted from the list 9. This list contains all the technical components and their individual parts. The article hierarchy is advantageously subdivided as far as the individual machine components. 8 and 9 transfer the data to the electronic instruction card 10, with the planning status being passed to the latter. From 10, the data are forwarded to 11, where the instruction planning is extended by offer data and the status is changed to instruction. At 11, the details from 12 also flow in. In 12, on the basis of the instruction card 10, orders are initiated, the delivery location is indicated and purchasing is informed as appropriate. The latter reacts by means of 13 requesting and 14 offering the requested parts. Work plan data are also put into the instruction card 10; a termination is input and also the cost center and the activity type code; in addition, any other necessary details for the work which is to be carried out. In 15, the instruction card is already given the instruction status and initiates an order 16 by means of a material request 17, 18 denotes the form of the instruction card in the present case. In 19, the instruction execution status exists, which leads to the instruction acknowledgement status via the main menu and via the instruction card. At this point, it is also possible to change the damage identifier via 21. In 21, the status of the instruction card is end message and completion, with the acknowledgement also being input together with the end message, and the instruction is logged when all items have been dealt with, and the material movements are also logged. In the case of internal charging, an invoice 22 is now created, the procedure being prompted by 23. In addition, checklists 24 containing text, remark lists 25 containing text and item counting lists 26 are created. In the status 27, the instruction is complete, is logged in 28 and the associated costs are logged in 29. The actual logging takes place at 30 and 31, with the cost center being logged in 31.

FIG. 5 is a graphical overview of the availability variables, with 33 signifying the total annual time of 365 days. This is then split. 34 signifies the intended busy time and 35 the unplanned time, i.e. Sundays and public holidays or the nightshift, when the time from 22.00 to 6.00 hrs is not used. 36 denotes the intended running time and 37 the non-busy time, i.e. the time in which no instructions were present. The intended running time is treated as the actual busy time for billing purposes. This actual busy time is divided, for billing purposes, into 38 the organizational downtime, 39 the actual running time, 40 the technical downtime and 41 the servicing time.

The technical busy time or intended running time 36 is the actual busy time which had been stipulated by the actual utilization level by production planning. The plant availability, also referred to as technical degree of utilization (N), is calculated on the basis of the formula below.

Plant availability=technical degree of utilization N=(1−(TAT/TB-ACT) )*100%

| | |
|---|---|
| T_{w}: | Servicing time |
| T_{AT}: | Technical downtime |
| T_{B-ACT}: | Technical busy time |
| T_{O}: | Organizational downtime |

The calculation is made according to the stipulations of VDI3423, that is to say advantageously on a neutral, reconstructable basis. Thus, disagreements with the external service provider about his recompense can be avoided.

The method steps to be attributed to the specific part of the instruction together result in a method for carrying out and billing for maintenance measures in industrial plants on the basis of a technical method sequence. In this respect, what is involved is the solution of a business management problem by means of computerized process and methodical steps. Overall, what is obtained is a device, a method and a process with a continuously technical character for objectively providing and billing for the services of an external, technical service provider in a manner which can be reconstructed.

1. A computerized system having at least one input/output unit and also processing and storage units, e.g. in the form of a PC, for optimizing and billing for the maintenance of an industrial plant for manufacturing goods, preferably food and luxury consumables, where the plant has, in particular, production machines for batch production and where the storage units contain a non-plant-specific relational database for recording detailed plant data, e.g. individual parts, at least one non-plant-specific main tool (software main tool) and further, plant-specific tools (software tools) for handling the data aspect of the maintenance.

2. The computerized system as claimed in claim 1, characterized in that it has a plant model in list form for machines and machine parts in the relational database, which plant model is designed to operate on the basis of SAP stipulations, for example.

3. The computerized system as claimed in claim 1 or 2 characterized in that it is designed to operate with standardized data relating to usability, utilization level and consumption of the machines.

4. The computerized system as claimed in claim 1, 2 or 3, characterized in that it has useful-life lists and lists for necessary maintenance measures depending on the useful life and use times of machines.

5. The computerized system as claimed in claim 1, 2, 3 or 4, characterized in that the main tool is designed for specifically handling individual sections.

6. The computerized system as claimed in claim 1, 2, 3, 4 or 5, characterized in that it contains maps of the maintenance processes in list form.

7. The computerized system as claimed in one or more of the preceding claims, characterized in that it is set up for handling the maintenance processes on the basis of electronic instruction cards which can be displayed.

8. The computerized system as claimed in one or more of the preceding claims, characterized in that it is designed for handling the maintenance processes using computer-generated flowcharts which preferably cannot be displayed.

9. The computerized system as claimed in one or more of the preceding claims, characterized in that it has operating data terminals or machine sensors used in relation to machines for the purpose of data entry.

10. The computerized system as claimed in one or more of claims 1 to 8, characterized in that it has a plant control system which can record and output data from individual machines, machine groups and from the entire plant.

11. The computerized system as claimed in one or more of the preceding claims, characterized in that, for the purpose of billing with an external maintainer, it has algorithms for calculating the availability achieved in practice in relation to the availability which can be achieved in theory.

12. The computerized system as claimed in claim 11, characterized in that it has algorithms for calculating a success-dependent remuneration for the maintenance.

13. The computerized system as claimed in one or more of the preceding claims, characterized in that it is used for the success-related maintenance of industrial plants.

14. A method, particularly as claimed in one or more of the preceding claims, for example for maintaining a plant in the food and luxury consumables industry, e.g. a coffee roasting establishment, in which a maintenance volume arising in the plant is split into an electrical main section, a mechanical main section, a buildings technology main section and a production-accompanying sector, with the electrical main section, the mechanical main section and the buildings technology main section each being broken down into a plannable and an unplannable maintenance volume sector and being processed using electronically produced instruction cards.

15. The method as claimed in claim 14, in which the electrical main section, the mechanical main section and the buildings technology main section each have a special-measures or project volume sector.

16. The method as claimed in claim 14 or 15, in which the electrical main section, the mechanical main section and the buildings technology main section each have a maintenance management volume sector.

17. The method as claimed in one of claims 14 to 16, in which the electrical main section, the mechanical main section and the buildings technology main section each have a spares procurement and furnishing volume sector.

18. The method as claimed in one of claims 14 to 17, in which the plannable maintenance volume sector of the electrical main section, of the mechanical main section and of the buildings technology main section is respectively split into an inspection sector, a servicing sector, a repair sector, an expendable-part procurement and furnishing sector and a consumables procurement and furnishing sector.

19. The method as claimed in one of claims 14 to 18, in which the timing for the unplannable maintenance volume sector of the electrical main section, of the mechanical main section and of the buildings technology main section is respectively split into a primary time sector and a secondary time sector.

20. The method as claimed in one of claims 14 to 19, in which the electrical main section is divided into an automation section, a control level section, a measurement and control section, a low voltage section, a drive and motor section, a valve section, a labeling and inscription device section and a documentation section.

21. The method as claimed in one of claims 14 to 20, in which the mechanical main section is divided into a fan section, a burner technology section, a mechanical engineering section, a mechanical conveying and handling section, an instrumentation section and a vacuum and compressed air section.

22. The method as claimed in one of claims 14 to 21, in which the buildings technology main section is divided into a telephone section, a fire alarm section, an elevator section, a fitter, painter, joiner and roofer section and a heating, sanitation, air-conditioning and ventilation section.

23. The method as claimed in one of claims 14 to 22, in which the maintenance volume arising in the plant is assigned an EDP sector.

24. The method as claimed in one of claims 14 to 23, in which the maintenance volume arising in the plant is split into sections and sectors such that a multiplicity of maintenance segments arises, each of which can be implemented separately.

25. The method as claimed in one of claims 14 to 24, in which each of the maintenance segments produced by splitting the maintenance volume arising in the plant into sectors and sections is assigned entirely or in part to a group or to a plurality of groups.

26. The method as claimed in one of claims 14 to 25, in which a first stage of a multistage, preferably four-stage process involves those maintenance segments of the inspection, servicing and repair sector which belong to the plannable maintenance volume sector of the electrical main section, of the mechanical main section and preferably also of the buildings technology main section being transferred from one group operating the plant to another group.

27. The method as claimed in claim 26, in which, in addition, the first stage of the process involves the maintenance segments which belong to the unplannable maintenance volume sector of the automation section, of the control level section and of the measurement and control section of the electrical main section being assigned to the other group in a comparatively high percentage, preferably 90%, in the primary time sector and entirely in the secondary time sector.

28. The method as claimed in claim 26 or 27, in which the maintenance segments belonging to the maintenance management volume sector of the electrical main section, of the mechanical main section and of the buildings technology main section are respectively distributed over the group operating the plant and the other group, preferably in a proportion of 50% each.

29. The method as claimed in one of claims 26 to 28, in which the production-accompanying sector is implemented by the group operating the plant.

30. The method as claimed in one of claims 26 to 29, in which the second stage of the preferably four-stage process involves the maintenance segments which belong to the unplannable maintenance volume sector of the low voltage section, of the drive and motor section, of the valve section, of the labeling and inscription device section and of the documentation section of the electrical main section being adopted by the other group as required.

31. The method as claimed in one of claims 26 to 30, in which the third stage of the preferably four-stage process involves the maintenance segments which belong to the unplannable maintenance volume sector of the buildings technology main section being adopted by the other group as required.

32. The method as claimed in one of claims 26 to 31, in which the fourth stage of the preferably four-stage process involves the maintenance segments which belong to the unplannable maintenance volume sector of the mechanical main section being adopted by the other group as required.

33. A method for maintaining a plant in the food and luxury consumables industry, e.g. a coffee roasting establishment, preferably as claimed in one of claims 14 to 32, in which a technical plant availability value is ascertained from the ratio between the plant's technical downtime, which is obtained from downtimes based on an inadequacy in the plant design or on inadequate servicing, and the technical busy time, which corresponds to the plant's ACTUAL busy time stipulated by the actual utilization level by the production program.

34. The method as claimed in claim 33, in which the ascertained technical plant availability value is stipulated as a recompense base value, with negative or positive deviations from the base value resulting in a reduction or in an increase in the recompense.

35. The method as claimed in claim 34, in which recompense of the other group on the basis of the technical plant availability value or base value starts at the beginning of the third stage of the preferably four-stage process.

36. The method as claimed in claim 34 or 35, in which the recompense base value stipulated on the basis of the technical plant availability value ascertained for one year is equated to the agreed annual maintenance budget for the next year which is to be paid to the other group.

37. The method as claimed in one of claims 34 to 36, in which, in the event of a negative or positive deviation in the actual technical plant availability value achieved in the current year from the ascertained technical plant availability value for the previous year which has been applied as a basis for the recompense base value for the current year, the maintenance recompense to be paid to the other group is reduced or increased by 0.5% of the annual maintenance budget ascertained for the current year for each percentage point of the negative or positive deviation.

38. The method as claimed in claim 37, in which the increase in the maintenance recompense or the reduction in the maintenance recompense is limited to 10% of the annual maintenance budget agreed for the current year.

39. The method as claimed in claim 37 or 38, in which an increase in the maintenance recompense which is to be paid to the other group per se is preferably split equally between the group operating the plant and the other group.

40. The method as claimed in one of claims 37 to 39, in which a reduction in the maintenance recompense which is to be withheld from the other group per se is preferably split equally between the group operating the plant and the other group.

41. The system as claimed in one or more of the preceding claims, characterized in that when it is introduced for an existing plant, step-by-step implementation takes place after the necessary data have been taken into the system until the envisaged final state has been achieved.
